(19) United States
(12) Patent Application Publication
(10) Pub. No.: US 2012/0249593 A1
(43) Pub. Date: Oct. 4, 2012

(54) IMAGE PROCESSING APPARATUS, IMAGE PROCESSING METHOD, AND RECORDING MEDIUM CAPABLE OF IDENTIFYING SUBJECT MOTION

(75) Inventor: Kouichi NAKAGOME, Tokyo (JP)

(73) Assignee: CASIO COMPUTER CO., LTD., Tokyo (JP)

(21) Appl. No.: 13/435,482

(22) Filed: Mar. 30, 2012

(30) Foreign Application Priority Data
Mar. 31, 2011 (JP) 2011-078392

(51) Int. Cl. G09G 5/00; G06K 9/00

(52) U.S. Cl. 345/634; 382/107

(57) ABSTRACT

An image capturing apparatus 1 includes an image obtaining section 51, a difference image generating section 54, an enhanced image generating section 55, a Hough transform section 562, and a position identifying section 153. The image obtaining section 51 obtains a plurality of image data where subject motion is captured continuously. The difference image generating section 54 generates difference image data between a plurality of image data temporally adjacent to each other, from the plurality of image data obtained by the image obtaining section 51. The enhanced image generating section 55 generates image data for identifying the subject motion, from the difference image data generated by the first difference image generating section. The position identifying section 153 identifies a change point of the subject motion, based on the image data generated by the enhanced image generating section 55.

This application is based on and claims the benefit of priority from Japanese Patent Application No. 2011-078392, filed on 31 Mar. 2011, the content of which is incorporated herein by reference.

### BACKGROUND OF THE INVENTION

1. Field of the Invention

The present invention relates to an image processing apparatus, an image processing method, and a recording medium that are capable of identifying subject motion from a plurality of images.

2. Related Art

Japanese Unexamined Patent Application, Publication No. 2006-263169 discloses a technique for imaging a series of motions relating to a golf club swing, to check golf club swing form.

Specifically, the motions of a person performing a golf club swing from the start to the end of the swing are captured continuously from a front direction. Then, from a plurality of images obtained as a result of the imaging, images corresponding to respective swing positions (e.g., top, impact, follow-through, etc.) are identified.

In addition, in the above-described Japanese Unexamined Patent Application, Publication No. 2006-263169, the above-described identification of images corresponding to swing positions is performed based on the number of frames set, and images of positions corresponding to the respective segments of the swing are determined.

### SUMMARY OF THE INVENTION

An object of the present invention is to provide an image processing apparatus, an image processing method, and a recording medium that are capable of improving, when subject motion is identified from a plurality of images, the accuracy of the identification.

To achieve the above-described object, an image processing apparatus according to one aspect of the present invention includes an obtaining section which obtains a plurality of image data in which a subject motion is captured continuously; a first generating section which generates difference image data between temporally adjacent ones of the plurality of image data; a second generating section which generates identifying image data for identifying the subject motion, based on the difference image data generated by the first generating section; and a change point identifying section which identifies a change point of the subject motion, based on the identifying image data generated by the second generating section.

In addition, to achieve the above-described object, an image processing method according to one aspect of the present invention includes an obtaining step of obtaining a plurality of image data in which a subject motion is captured continuously; a first generating step of generating difference image data between temporally adjacent ones of the plurality of image data; a second generating step of generating identifying image data for identifying the subject motion, based on the difference image data generated by a process in the first generating step; and a change point identifying step of identifying a change point of the subject motion, based on the identifying image data generated by a process in the second generating step.

In addition, to achieve the above-described object, a recording medium readable by a computer and recording a program that causes the computer to function as: an obtaining section which obtains a plurality of image data in which a subject motion is captured continuously; a first generating section which generates difference image data between temporally adjacent ones of the plurality of image data; a second generating section which generates identifying image data for identifying the subject motion, based on the difference image data generated by the first generating section; and a change point identifying section which identifies a change point of the subject motion, based on the identifying image data generated by the second generating section.

### BRIEF DESCRIPTION OF THE DRAWINGS

FIG. 1 is a block diagram showing a hardware configuration of an image capturing apparatus according to an embodiment of the present invention;

FIG. 2 is a functional block diagram showing functional configurations for performing a graph display process, among the functional configurations of the image capturing apparatus in FIG. 1;

FIG. 3 is a functional block diagram showing functional configurations for performing a graph display process, among the functional configurations of the image capturing apparatus in FIG. 1;

FIG. 4 is a flowchart showing the operation of a graph display process of the image capturing apparatus in the present embodiment;

FIG. 5 is a schematic diagram for describing an example of a technique for specifying, by a user, a ball position in an initial frame;

FIG. 6 is a schematic diagram showing an example of the process up to the point where data on an enhanced image Ct is generated from data on continuously captured images Pt;

FIGS. 7A and 7B are a diagram showing an example of a graph showing sinusoidal curves obtained by performing a Hough transform according to equation (2);

FIG. 8 is a graph showing changes in club angle in captured images of a swing captured;

FIG. 9 is a graph showing identified swing positions in a graph showing the relationship between the angle of rotation of the club and the frame in FIG. 8;

FIG. 10 is a flowchart showing the operation of a pixel rewrite process for an enhanced image Ct; and

FIGS. 11A to 11D are schematic diagrams showing determination of a non-voting region.

### DETAILED DESCRIPTION OF THE INVENTION

An embodiment of the present invention will be described below using the drawings.

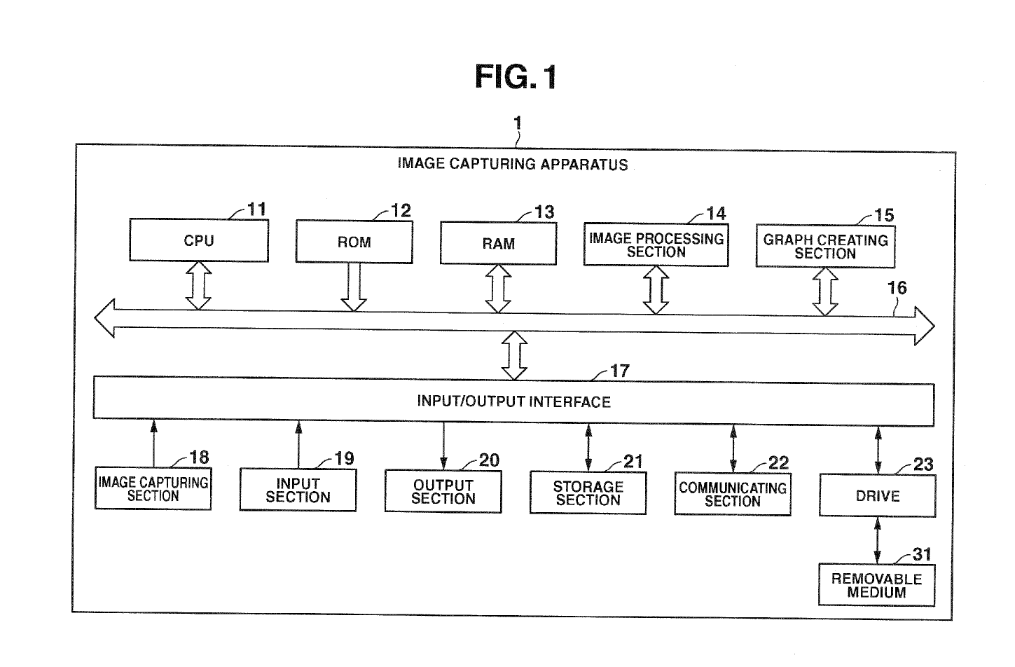

FIG. 1 is a block diagram showing a hardware configuration of an image capturing apparatus according to an embodiment of the present invention. An image capturing apparatus 1 is configured as, for example, a digital camera.

The image capturing apparatus 1 includes a CPU (Central Processing Unit) 11, a ROM (Read Only Memory) 12, a RAM (Random Access Memory) 13, an image processing section 14, a graph generating section 15, a bus 16, an input/output interface 17, an image capturing section 18, an input section 19, an output section 20, a storage section 21, a communicating section 22, and a drive 23.

The CPU 11 performs various processes according to a program recorded in the ROM 12 or a program loaded into the RAM 13 from the storage section 21.

Data, etc., required when the CPU 11 performs various processes are also appropriately stored in the RAM 13.

The image processing section 14 performs image processing on various image data stored in the storage section 21, etc. The image processing section 14 will be described in detail later.

The graph generating section 15 generates a graph from various data. The graph generating section 15 will be described in detail later.

Here, a graph refers to a diagram that visually represents changes in quantity over time, a magnitude relation, a ratio, etc. In addition, “to generate a graph” or “to graph” refers to the process of generating data on an image including a graph (hereinafter, also referred to as “graph data”).

The CPU 11, the ROM 12, the RAM 13, the image processing section 14, and the graph generating section 15 are connected to one another via the bus 16. The input/output interface 17 is also connected to the bus 16. To the input/output interface 17 are connected the image capturing section 18, the input section 19, the output section 20, the storage section 21, the communicating section 22, and the drive 23.

The image capturing section 18 includes, though not shown, an optical lens section and an image sensor.

The optical lens section includes a lens that collects light, e.g., a focus lens, or a zoom lens, to capture a subject.

The focus lens is a lens for forming a subject image on a light-receiving surface of the image sensor. The zoom lens is a lens for freely changing the focal distance within a certain range.

The optical lens section is also provided with a peripheral circuit, if necessary, that adjusts setting parameters such as a focal point, exposure, and white balance.

The image sensor includes a photoelectric conversion element, and an AFE (Analog Front End).

The photoelectric conversion element is composed of, for example, a CMOS (Complementary Metal Oxide Semiconductor) type photoelectric conversion element. A subject image enters the photoelectric conversion element from the optical lens section. Hence, the photoelectric conversion element photoelectrically converts (images) a subject image and accumulates an image signal for a fixed period of time, and sequentially supplies the accumulated image signal to the AFE, as an analog signal.

The AFE performs various signal processing such as an A/D (Analog/Digital) conversion process, on the analog image signal. By the various signal processing, a digital signal is generated and output as an output signal from the image capturing section 18.

Such an output signal from the image capturing section 18 is hereinafter called “captured image data”. The captured image data is appropriately supplied to the CPU 11, the image processing section 14, etc.

The input section 19 includes various buttons, and accepts, as input, various information according to user's instruction operation.

The output section 20 includes a display, and a speaker, and outputs images and audio.

The storage section 21 includes a hard disk, or a DRAM (Dynamic Random Access Memory), and stores data on various images.

The communicating section 22 controls communication performed with another apparatus (not shown) over a network including the Internet.

A removable medium 31 such as a magnetic disk, an optical disk, a magneto-optical disk, or a semiconductor memory is appropriately inserted into the drive 23. A program read from the removable medium 31 by the drive 23 is installed on the storage section 21 as necessary. The removable medium 31 can also store various data such as data on images stored in the storage section 21, as with the storage section 21.

Next, of the functional configurations of the image capturing apparatus 1, functional configurations for performing a graph display process will be described.

The graph display process refers to a series of processes from the creation of a graph representing changes in club position (club shaft position) during a swing up to the display of the graph.

For more specific processes, first, a plurality of captured images are selected from a moving image obtained as a result of imaging a series of subject's golf swing motions.

Then, golf club positions are extracted from the plurality of selected captured images.

Then, based on the extraction results, a graph representing changes in club position during a swing is generated and displayed.

A series of processes such as those described above are referred to as a graph display process.

Here, the moving image includes not only so-called video but also a set of a plurality of captured images which are captured by continuous capturing. Namely, a moving image obtained by imaging is configured by a plurality of captured images (hereinafter, called “unit images”) such as frames or fields being arranged continuously.

Note that although here for the simplification of description an example in which a right-handed subject is captured and a graph representing changes in club position is generated from the captured images will be described as a specific example, for the case of a left-handed subject, too, a graph can be generated in exactly the same manner.

First, of the functional configurations of the image capturing apparatus 1, functional configurations for performing a graph display process relating to the creation of a graph will be described below. Then, of the functional configurations of the image capturing apparatus 1, functional configurations for performing a graph display process relating to the display of a graph will be described.

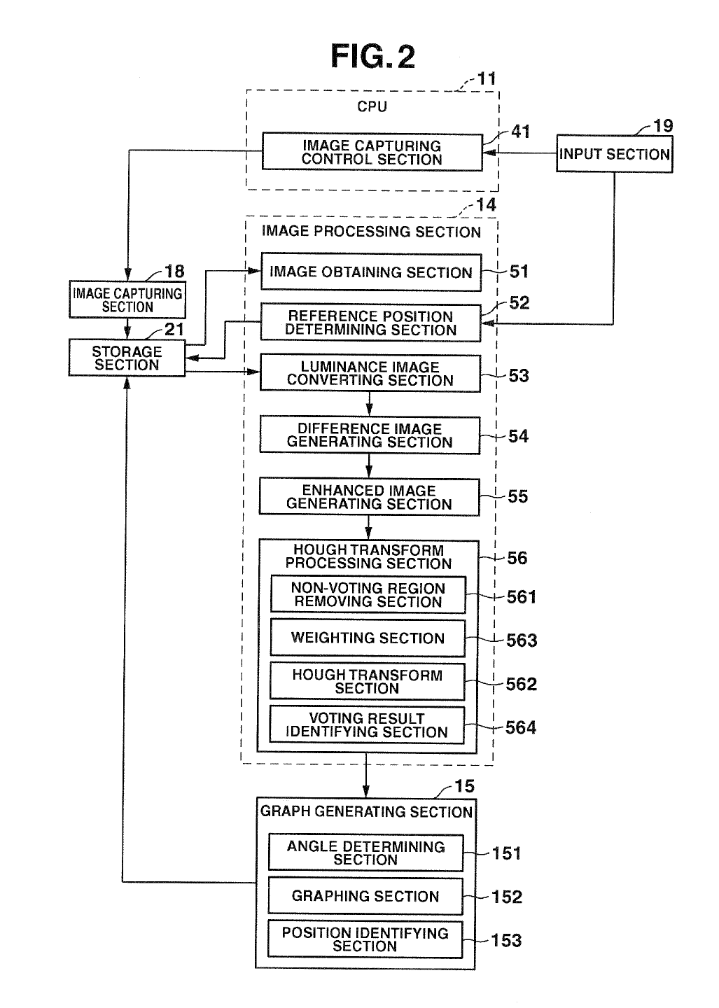

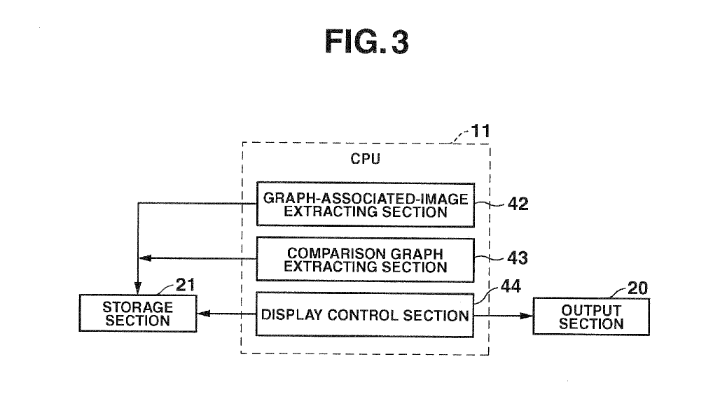

FIGS. 2 and 3 are functional block diagrams showing functional configurations for performing a graph display process, among the functional configurations of the image capturing apparatus 1 in FIG. 1.

In the CPU 11, upon performing pre-processing of a graph display process, an image capturing control section 41 shown in FIG. 2 functions.

The image capturing control section 41 controls imaging operation in response to input operation to the input section 19 from a user. In the present embodiment, the image capturing control section 41 controls such that the image capturing section 18 repeatedly and continuously images a subject at predetermined time intervals. By the control of the image capturing control section 41, each of data on captured images which are sequentially output from the image capturing section 18 every predetermined time interval is stored in the storage section 21. Namely, each of data on a plurality of captured images which are sequentially stored in the storage section 21 in the order in which the data are output from the image capturing section 18, during the period from the start to the end of control of the image capturing control section 41 serves as unit image data. An aggregate of the plurality of unit image data composes a single moving image data. Note that in the following for the simplification of description a unit image (captured image) is a frame.

In the image processing section 14, upon performing a graph display process or its pre-processing, as shown in FIG. 2, an image obtaining section 51, a reference position determining section 52, an luminance image converting section 53, a difference image generating section 54, an enhanced image generating section 55, and a Hough transform processing section 56 function.

The image obtaining section 51 obtains data on T frames (T is an integer value greater than or equal to 2) from data on a plurality of frames (unit images) which are captured by the image capturing section 18 and compose moving image data.

In the present embodiment, the frame data obtained by the image obtaining section 51 are seven (=T) frame (captured image) data respectively showing scenes where the subject takes seven predetermined types of swing positions, in a moving image showing a series of swing motions.

Here, in the present embodiment, the seven predetermined types of swing positions include: “address” position, “take-away” position, “top” position, “downswing” position, “impact” position, “follow-through” position, and “finish” position.

The reference position determining section 52 determines, when the user points to a ball position in a moving image by operating the input section 19, the ball position to be a reference position. The reference position thus determined is used upon determination of a non-voting region which is made to improve club extraction accuracy in a Hough transform which will be described later.

Note that although here a reference position is determined manually by the user operating the input section 19, the way to determine a reference position is not particularly limited thereto, and the image capturing apparatus 1 may make an autonomous determination without involvement of user's operation, i.e., make a determination automatically. For example, the image capturing apparatus 1 may determine a ball position from the shape, color, etc., of a ball by analyzing moving image data. For example, the image capturing apparatus 1 can automatically determine a ball position using a circular separation filter, etc.

The luminance image converting section 53 converts the plurality of frame (color image) data obtained by the image obtaining section 51 into image data having only luminance values as pixel values (hereinafter, called “luminance image data”).

The difference image generating section 54 generates difference image data by taking a difference between two predetermined luminance image data among a plurality of luminance image data obtained after the conversion by the luminance image converting section 53.

In the present embodiment, the difference image generating section 54 takes a difference between data on two luminance images arranged in imaging order, i.e., two luminance images adjacent to each other in chronological order, and thereby generates difference image data. The expression “take a difference between data” as used herein refers to taking a difference between pixel values (luminance values because they are the pixel values of luminance images) for each pixel.

Specifically, the difference image generating section 54 takes a difference between data on an luminance image corresponding to the first frame captured and data on an luminance image corresponding to the second frame captured in the range of luminance images obtained by the image obtaining section 51, and thereby generates the first difference image data.

In addition, the difference image generating section 54 takes a difference between data on the luminance image corresponding to the second frame captured and data on an luminance image corresponding to the third frame captured, and thereby generates the second difference image data.

In this manner, the difference image generating section 54 sequentially generates difference image data in the range of luminance images obtained by the image obtaining section 51, for all of the luminance images.

The enhanced image generating section 55 multiplies together the pixel values of a difference image which is a processing target and the pixel values of a difference image that is earlier in imaging order than the processing target among the plurality of difference image data generated by the difference image generating section 54, and thereby generates enhanced image data in which an identical portion in the two multiplied difference images is enhanced.

Specifically, making description using the aforementioned example, it is assumed that data on a difference image which is a processing target is obtained by a difference between data on the K+1th frame (K is an integer value greater than or equal to 2) and data on the Kth frame. In this case, a difference image that is earlier in imaging order than the processing target is one obtained by a difference between data on the Kth frame and data on the K−1th frame. Therefore, an identical portion in two multiplied difference images refers to a portion corresponding to the Kth luminance image. Hence, enhanced image data in which a portion corresponding to the Kth luminance image is enhanced is obtained.

The Hough transform processing section 56 performs a Hough transform on the enhanced image data generated by the enhanced image generating section 55. Here, the Hough transform refers to an image processing technique for transforming each pixel identified in a Cartesian coordinate system into a sinusoidal curve in the Hough space in order to detect (extract) a straight line (in the present embodiment, a straight line passing through the club) in an image.

In addition, in the present embodiment, passing of a sinusoidal curve in the Hough space through the coordinates of a given feature point refers to “Hough voting”.

In the present embodiment, a straight line of the club in the Cartesian coordinate system can be extracted by determining the coordinates of a feature point through which the highest number of sinusoidal curves in the Hough space with weighting being considered pass (by determining coordinates in the Hough space with the highest number of Hough votes).

Specifically, the Hough transform processing section 56 includes a non-voting region removing section 561, a Hough transform section 562, a weighting section 563, and a voting result identifying section 564.

The non-voting region removing section 561 removes, from a Hough voting target, data in a region that is not reflected in voting after a Hough transform which will be described later (hereinafter, called a “non-voting region”) among data on an enhanced image generated by the enhanced image generating section 55. An enhanced image where a non-voting region is removed is hereinafter referred to as a “non-voting region removed image”.

Here, the non-voting region refers to a region distanced from a club position which is sequentially expected based on the imaging order. In addition, the non-voting region refers to a region that may possibly allow a straight line other than the club to be extracted if the region is reflected in voting after a Hough transform, and thus may decrease the extraction accuracy of a club's straight line.

Specifically, the non-voting region removing section 561 removes data in a non-voting region from a Hough voting target by rewriting each pixel value of a pixel group composing a region that is not reflected in voting after a Hough transform to, for example, “0”.

A non-voting region is determined based on the angle of a straight line (a club's approximate straight line) identified in an enhanced image preceding by one in imaging order.

Here, in the present embodiment, for the origin of the angle of a straight line, an angle that is perpendicular to a horizontal plane of an image is the origin (0 degrees) and the angle increases clockwise (the positive direction of the angle is clockwise).

Note that taking into account that the first enhanced image including the first frame in the range of luminance images obtained by the image obtaining section 51 is an enhanced image where a frame near address position is enhanced, the angle (the angle of rotation) of the club (its approximate straight line) is between 0 and 45 degrees. Therefore, the non-voting region removing section 561 removes regions other than the region between 0 and 45 degrees as much as possible, as Hough voting targets.

In the present embodiment, the non-voting region ranges are from 0 degrees to 45 degrees, from 45 degrees to 135 degrees, from 135 degrees to 210 degrees, from 210 degrees to 270 degrees, and from 270 degrees to 320 degrees. Then, regions other than an identified voting region are removed as much as possible, as Hough voting targets. For example, when a region between 45 degrees and 135 degrees is identified as a voting region, regions with other angles are removed as much as possible. In addition, regardless of which angle position to be predicted, the club is never located lower than the ball position, and thus, a region lower in position than the reference position determined by the reference position determining section 52 is removed as a Hough voting target.

The Hough transform section 562 performs a Hough transform on data on a non-voting region removed image and thereby brings a club's approximate straight line in the non-voting region removed image to an identifiable state.

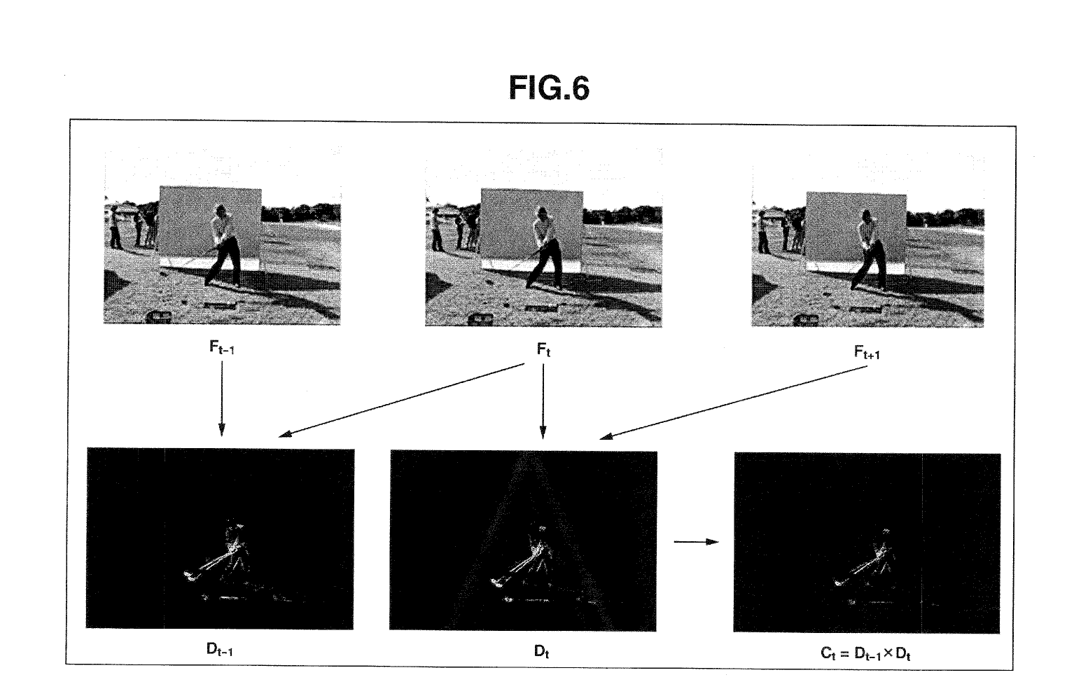

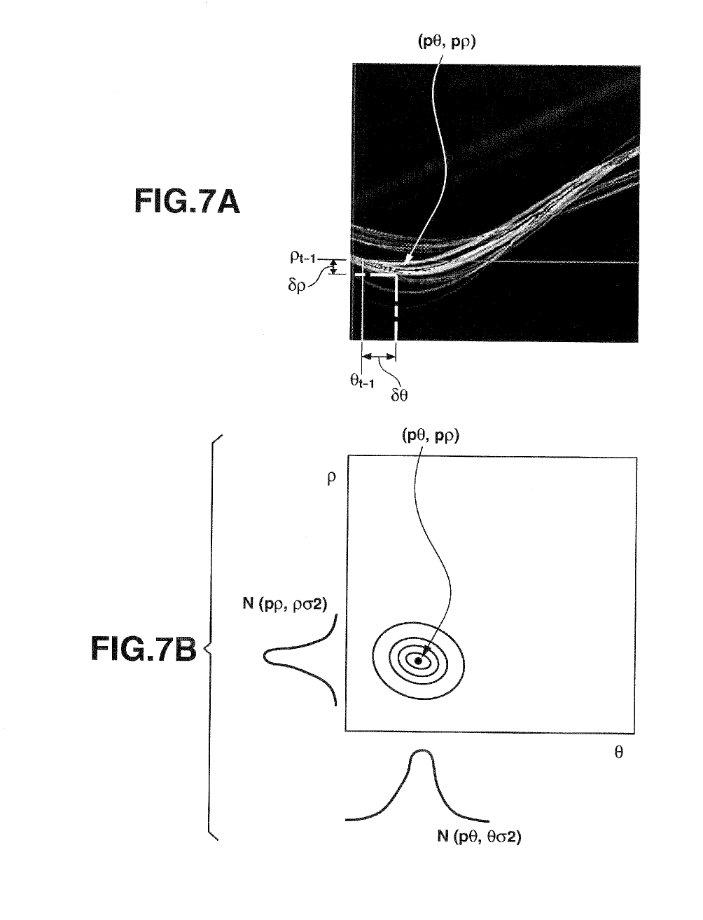

Specifically, the Hough transform section 562 performs a Hough transform on an enhanced image Ct in FIG. 6 so that a graph showing sinusoidal curves such as that shown in FIG. 7A can be obtained (a detail will be described later).

The weighting section 563 increases weighting such that, as shown in FIG. 7B, based on the position of a club's approximate straight line (hereinafter, referred to as a “straight line position”) which is predicted based on the image imaging order, weighting of voting results in a neighboring region of the straight line position increases.

The voting result identifying section 564 identifies coordinates at which the highest number of curves calculated by a Hough space by the Hough transform section 562 intersect in the Hough transform weighted by the weighting section 563.

Specifically, the voting result identifying section 564 evaluates, as shown in FIG. 7A, the number of sinusoidal curves passing through (hereinafter, referred to as a “Hough voting value”) according to the weighting determined by the weighting section 563, and identifies coordinates (θ, ρ) at which the highest Hough voting value is obtained.

The Hough transform section 562 performs an inverse Hough transform on such coordinates at which the highest number of votes is obtained, and thereby identifies a region indicating a club's approximate straight line in a non-voting region removed image.

Here, the graph generating section 15 includes an angle determining section 151, a graphing section 152, and a position identifying section 153.

The angle determining section 151 determines an angle formed by a club's approximate straight line (hereinafter, referred to as a “straight line angle”) in an image, based on an identification result obtained by the voting result identifying section 564.

The graphing section 152 generates data on an image including a graph (graph image) where the straight line angles (club angles) in respective images which are determined by the angle determining section 151 in image imaging order are displayed.

The position identifying section 153 identifies a subject's swing position from the relationship between the image imaging order (chronological order) and the straight line angle in each image.

Specifically, the position identifying section 153 identifies, as an address position, a subject's position included in the first image where the angle is about 0 degrees.

In addition, the position identifying section 153 identifies, as a finish position, a subject's position included in the last image.

In addition, the position identifying section 153 identifies, as a top position, a subject's position included in an image where the rotation changes from forward one to reverse one.

In addition, the position identifying section 153 identifies, as a take-away position, subject's positions included in images starting from a subject's position included in the image identified as the top position to the address position.

In addition, the position identifying section 153 identifies, as an impact position, a subject's position included in an image where the club angle after the top position is about 0 degrees which is the same as that for the address position.

In addition, the position identifying section 153 identifies, as a follow-through position, subject's positions starting from one included in an image after the impact position to one included in an image before the finish position.

Of the functional configurations of the image capturing apparatus 1, the functional configurations for performing a graph display process relating to the creation of a graph are described above. Next, of the functional configurations of the image capturing apparatus 1, functional configurations for performing a graph display process relating to the display of a graph will be described.

When, of the graph display process, a process relating to the creation of a graph is thus completed, a process relating to the display of a graph is performed. In this case, as shown in FIG. 3, in the CPU 11, a graph-associated-image extracting section 42, a comparison graph extracting section 43, and a display control section 44 function.

When, with a graph being displayed on the output section 20, a predetermined position in the graph is pointed to by operation performed by the user on the input section 19, the graph-associated-image extracting section 42 extracts data on an captured image (frame) which is captured at a time associated with the pointed position, from the storage section 21.

The comparison graph extracting section 43 extracts comparison graph data which is stored in advance in the storage section 21. The comparison graph data is to make a comparison with graph data newly generated by the graphing section 152. It is sufficient that the comparison graph data be graph data different from the graph data newly generated, and the number and type thereof are not particularly limited. For example, graph data generated when the same performer (subject) who has performed a series of golf swing motions shown in a newly generated graph has performed another series of golf swing motions in the past may be adopted as comparison graph data. Alternatively, graph data generated when another person such as a professional golfer has performed a series of golf swing motions may be adopted as comparison graph data.

A viewer who views a newly generated graph can easily evaluate golf swing form by comparing the graph with a comparison graph.

The display control section 44 performs control to allow an image including a graph generated as data by the graphing section 152 to be displayed and output from the output section 20.

In this case, the display control section 44 may allow a comparison graph extracted by the comparison graph extracting section 43 to be displayed and output from the output section 20 together with the graph (in a superimposed manner) or instead of the graph (by erasing the graph).

Likewise, the display control section 44 may allow a frame (captured image) extracted as data by the graph-associated-image extracting section 42 to be displayed and output from the output section 20 together with the graph (in a superimposed manner) or instead of the graph (by erasing the graph).

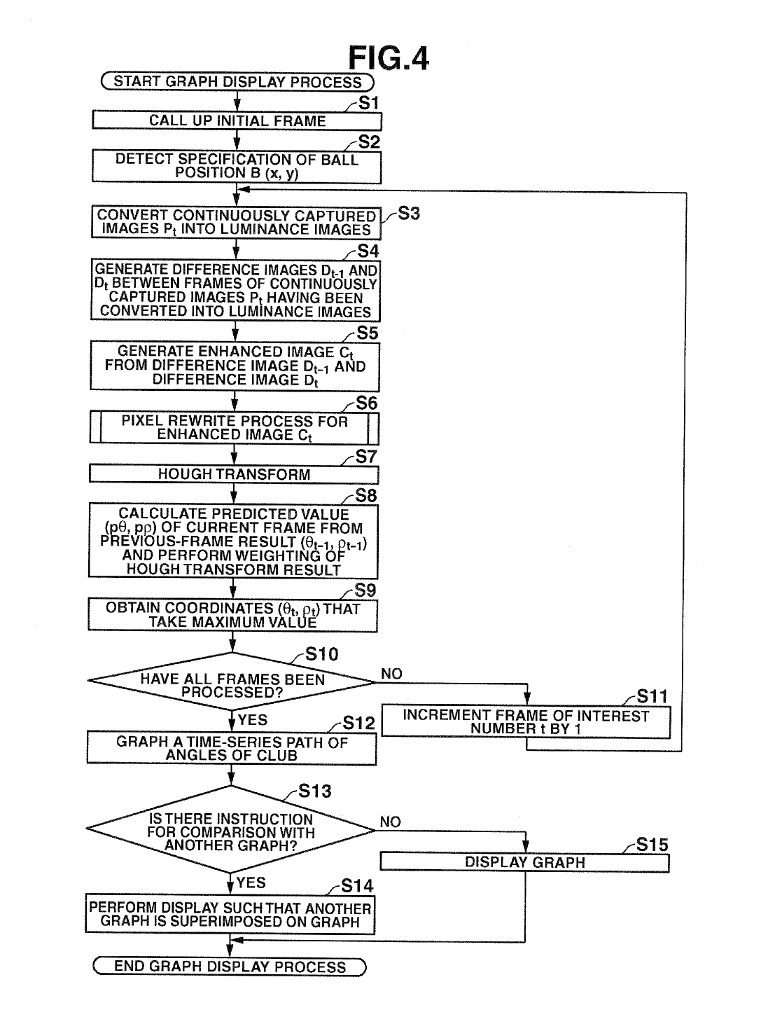

Next, the flow of the operation of a graph display process of the image capturing apparatus 1 in the present embodiment will be described using FIG. 4. FIG. 4 is a flowchart showing the operation of a graph display process of the image capturing apparatus 1 in the present embodiment.

By pre-processing of a graph display process, with a person performing a golf swing being a subject, a series of swing motions are captured in advance by the image capturing section 18, and moving image data obtained as a result of the imaging is stored in advance in the storage section 21.

When, with such pre-processing having been performed, a user performs predetermined operation using the input section 19, a graph display process in FIG. 4 starts and processes such as those shown below are performed.

At step S1, the image obtaining section 51 calls up an initial frame. Specifically, the image obtaining section 51 obtains, as initial frame data, data on the first captured image (frame) where the subject at address position is photographed, among the moving image data stored in the storage section 21.

At step S2, the reference position determining section 52 determines a ball position B (x, y).

Specifically, in the present embodiment, the initial frame called up in the process at step S1 is displayed on a display section of the output section 20. The user specifies a position where it can be determined that a ball is placed, in the displayed initial frame by operating the input section 19. The reference position determining section 52 determines the position B (x, y) thus specified by the user to be a ball position B (x, y).

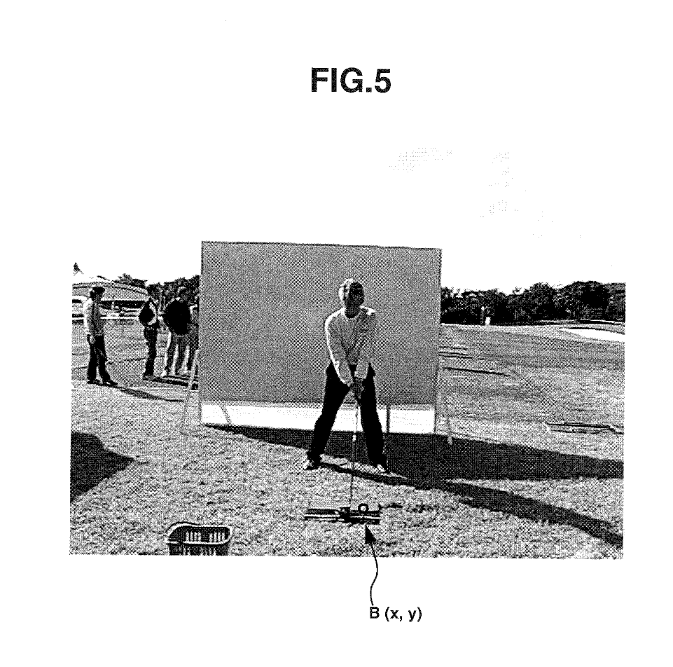

FIG. 5 is a schematic diagram for describing an example of a technique for specifying, by the user, a ball position in the initial frame.

As shown in FIG. 5, the user can specify a ball position B (x, y) by moving a cursor in the display unit of the output section 20 to the ball position by operating the input section 19 (e.g., a mouse), and then performing click operation.

In this manner, by the process at step S2, a reference position used upon determination of a non-voting region which will be described later is determined.

At step S3, the luminance image converting section 53 converts data on continuously captured images Pt into luminance image data. Here, the data on continuously captured images Pt refers to an aggregate of data on a frame of interest Ft and frames Ft−1 and Ft+1 before and after the frame of interest Ft when the tth frame Ft among a plurality of frame data obtained by the image obtaining section 51 is the frame of interest (processing target frame).

Therefore, the frames Ft−1, Ft, and Ft+1 are obtained by the image obtaining section 51, and are converted by the luminance image converting section 53 into luminance image data.

In practice, in the present embodiment, the image obtaining section 51 obtains a plurality of frame data respectively showing scenes from an address state to a finish state. Therefore, the first frame F1 is an captured image corresponding to address position and the last frame is an captured image corresponding to finish position. The first frame F1 corresponding to address position and the last frame corresponding to finish position are identified based on, for example, a comparison with reference images for positions which are stored as data in advance in the storage section 21.

At step S4, the difference image generating section 54 generates data on each of frame-to-frame difference images Dt−1 and Dt from the data on the continuously captured images Pt converted into luminance images.

At step S5, the enhanced image generating section 55 generates data on an enhanced image Ct from the data on the difference images Dt−1 and Dt.

FIG. 6 is a schematic diagram showing an example of the process up to the point where data on an enhanced image Ct is generated from data on continuously captured images Pt.

As shown in FIG. 6, a tth frame Ft serves as a frame of interest (a target frame for generating an enhanced image) and the frame of interest and adjacent frames before and after the frame of interest, i.e., a frame Ft−1, a frame Ft, and a frame Ft+1, are obtained by the image obtaining section 51.

In the process at step S3, each data on each of the frames Ft−1, Ft, and Ft+1 is converted into luminance image data by the luminance image converting section 53 (luminance images are not shown in the same drawing).

Then, in the process at step S4, each data on difference images Dt−1 and Dt is generated by the difference image generating section 54. Specifically, data on a difference image Dt−1 is generated from a difference between the data on the frame Ft−1 and the data on the frame of interest Ft. In addition, data on a difference image Dt is generated from a difference between the data on the frame of interest Ft and the data on the frame Ft+1.

Then, in the process at step S5, the data on the difference images Dt−1 and Dt are multiplied together by the enhanced image generating section 55, thereby generating data on an enhanced image Ct.

The enhanced image Ct is an image obtained by multiplying together adjacent difference images Dt−1 and Dt between a reference frame and frames Ft−1 and Ft+1 before and after the reference frame, with a frame of interest Ft being the reference frame. Hence, in the enhanced image Ct, a matching portion between the adjacent difference images Dt−1 and Dt, particularly, a portion representing a club in the frame of interest Ft is enhanced.

At step S6, the non-voting region removing section 561 performs a pixel rewrite process for the enhanced image Ct and thereby generates non-voting region removed image data. The pixel rewrite process refers to a process in which a non-voting region is determined based on a club position which is predicted from a frame earlier in imaging order than the frame of interest Ft, among the pixels composing the enhanced image Ct, and the pixel values (data) of pixels composing the non-voting region are rewritten to values that are not considered as a voting target, e.g., “0”. A more detail of the pixel rewrite process for the enhanced image Ct will be described later. By using, in a subsequent process, the non-voting region removed image data generated by the process at step S6, the extraction accuracy of a club's approximate straight line improves.

At step S7, the Hough transform section 562 performs a Hough transform on the non-voting region removed image data.

Specifically, a pixel at a pixel position (x, y) in the non-voting region removed image is transformed into a sinusoidal curve in the Hough space formed by a θ axis and a ρ axis, according to the following equation (1). Here, ρ indicates the distance from the origin.

ρ=x cos θ+y sin θ (1)

FIG. 7 shows an example of a graph showing sinusoidal curves obtained as a result of a Hough transform according to the equation (1).

Namely, when a Hough transform is performed on the non-voting region removed image data in the process at step S7, Hough votable curves (white lines) such as those shown in FIG. 7A are extracted.

At step S8, the weighting section 563 calculates a predicted value (pθ, pρ) of the current frame of interest Ft from the result of a Hough transform for a frame Ft which was a frame of interest last time (θt−1, ρt−1) (hereinafter, referred to as “previous-frame result (θt−1, ρt−1)”), and thereby performs weighting of a Hough transform result.

Specifically, the weighting section 563 performs weighting by computing according to the following equations (2) and (3) such that, as shown in FIG. 7B, the Hough voting value in a region near an estimated club position is highly evaluated.

δθ=k(θₜ₋₂−θₜ₋₃)+(1−k) (θₜ₋₁−θₜ₋₂)(0≦k≦1) (2)

δρ=l(ρₜ₋₂−ρₜ₋₃)+(1−l)(ρₜ₋₁−ρₜ₋₂)(0≦l≦1) (3)

Namely, as shown in FIG. 7B, weighting is set to be highest at the coordinate position of a predicted result of a club's approximate straight line in the frame of interest Ft which is predicted from a club angle in a previous frame, and to gradually decrease as going outward from the coordinate position.

Note that in the present embodiment the values of k and l are values between 0.3 and 0.8.

At step S9, the voting result identifying section 564 obtains coordinates (θt, ρt) that take the maximum value. Then, the Hough transform section 562 performs an inverse Hough transform based on the obtained coordinates (θt, ρt) that take the maximum value, and thereby determines a club's approximate straight line in the frame of interest Ft. An angle (club angle) of the determined club's approximate straight line is identified by the angle determining section 151. In this manner, the angle of the straight line in the frame of interest Ft is identified.

At step S10, the CPU 11 determines whether all frames have been processed. Namely, it is determined whether all frames have been set to be frames of interest and the process of identifying a club angle in each frame (processes from step S5 to step S9) has been performed.

If there is a frame that is not yet set to be a frame of interest, then it is determined to be NO at step S10 and thus processing proceeds to step S11.

At step S11, the CPU 11 increments the frame of interest number t by 1 (t=t+1). By this, the next frame is set to be a frame of interest and processing proceeds to step S3 and subsequent processes are performed, by which a club angle in the frame of interest is identified.

By setting all frames to be frames of interest and repeatedly performing such a loop process from steps S3 to S11 every time a frame is set to be a frame of interest, club angles in all of the frames are identified. By doing so, it is determined to be YES at step S10 and thus processing proceeds to step S12.

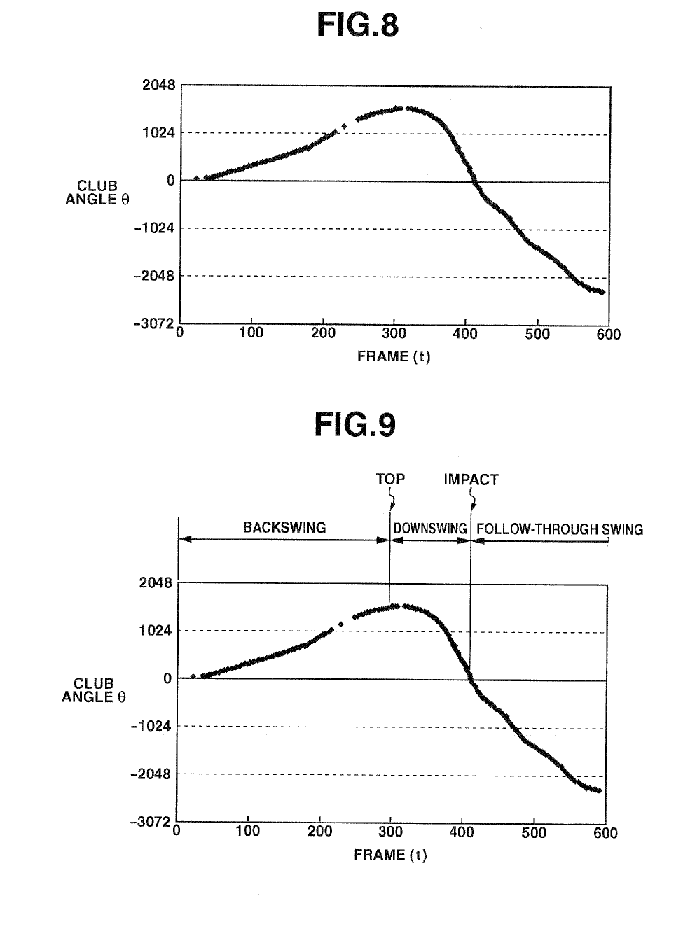

At step S12, the graphing section 152 graphs a time-series path of the club angles. Specifically, the graphing section 152 generates a displayable graph image by arranging the calculated club angles in the respective frames in chronological order of imaging order (see FIG. 8). FIG. 8 shows a graph showing changes in club angle in captured images of a swing captured. In the graph, the vertical axis represents club angles (θ) and the horizontal axis represents frames in imaging time order.

In addition, upon graphing, as shown in FIG. 9, the position identifying section 153 identifies swing positions from the club angles and the frame imaging order. In the present embodiment, the range from the first frame to a frame with an angle with reverse rotation (a frame where the increase in angle converges) is a backswing motion range, and the range from a frame where a backswing motion is performed to a frame where the angle reaches 0 degrees is a downswing motion range. At this time, a frame where the backswing motion changes is a top and a frame where the angle of the downswing motion reaches 0 degrees is an impact. In addition, the range of frames after the impact is a follow-through swing motion. FIG. 9 shows a graph showing swing positions identified from the graph showing the relationship between the club angle and the frame in FIG. 8.

At step S13, the CPU 11 determines whether there is an instruction for comparison with a comparison graph. Specifically, the CPU 11 determines whether input operation for a comparison instruction has been performed on the input section 19 by the user.

If the input operation for a comparison instruction has been performed on the input section 19 by the user, then the process is YES and thus processing proceeds to step S14.

If the input operation for a comparison instruction has not been performed on the input section 19 by the user, then the process is NO and thus processing proceeds to step S15.

At step S14, the output section 20 performs display such that a comparison graph is superimposed on the graph. Specifically, since the input operation for a comparison instruction has been performed, a comparison graph is obtained by the comparison graph extracting section 43 from the storage section 21. Thereafter, the display control section 44 controls the display and output of the output section 20 such that the comparison graph and the graph generated by this process are displayed in a superimposed manner. Thereafter, the process ends.

At step S15, the output section 20 displays the graph. Specifically, the output section 20 is controlled by the display control section 44 to display the generated graph. Thereafter, the process ends.

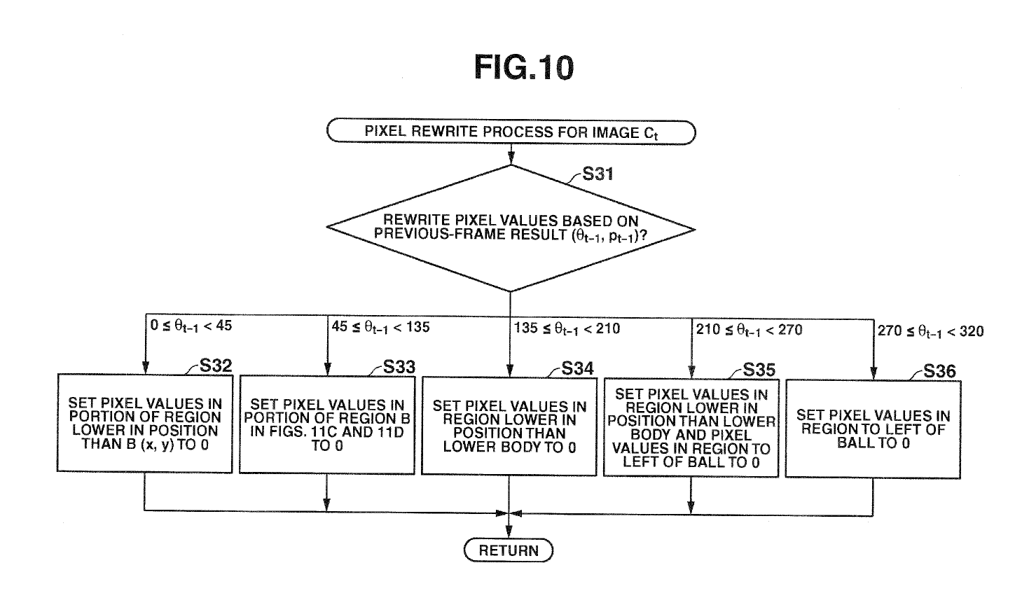

Next, the flow of the operation of a pixel rewrite process for an enhanced image Ct at step S6 will be described using FIG. 10. FIG. 10 is a flowchart showing the operation of a pixel rewrite process for an enhanced image Ct.

At step S31, the non-voting region removing section 561 rewrites pixel values based on a previous-frame result (θt−1, ρt−1). At a subsequent step, the non-voting region removing section 561 determines a non-voting region according to a club angle which is expected based on the previous-frame result (θt−1, ρt−1), and sets the pixel values in the corresponding region to 0.

For example, in the case of the second frame (in the case in which the previous frame is the first frame), since the first frame is an address position image, the club angle is 0. Hence, since the expected club angle is between 0 degrees and 45 degrees (0≦θₜ₋₁<45), processing proceeds to step S32.

In the case in which the club angle in the previous frame is close to 45 degrees and it is expected, judging from the way the angle changes between the frames, that the club angle exceeds 45 degrees, since the club angle is between 45 degrees and 135 degrees (45≦θₜ₋₁<135), processing proceeds to step S33.

In the case in which the club angle in the previous frame is close to 135 degrees and it is expected, judging from the way the angle changes between the frames, that the club angle exceeds 135 degrees, since the angle of club is between 135 degrees and 210 degrees (135≦θₜ₋₁<210), processing proceeds to step S34.

In the case in which the angle of rotation in the previous frame is close to 210 degrees and it is expected, judging from the way the angle changes between the frames, that the club angle exceeds 210 degrees, since the angle of club is between 210 degrees and 270 degrees (210≦θₜ₋₁<270), processing proceeds to step S35.

In the case in which the club angle in the previous frame is close to 270 degrees and it is expected, judging from the way the angle changes between the frames, that the club angle exceeds 270 degrees, since the club angle is between 270 degrees and 320 degrees (270≦θₜ₋₁<320), processing proceeds to step S36.

Note that due to the golf swing characteristics, the club angle change is the same for from the address to the top and from the top to the finish.

At step S32, the non-voting region removing section 561 sets the pixel values in the portion of a region lower in position than B (x, y) to 0.

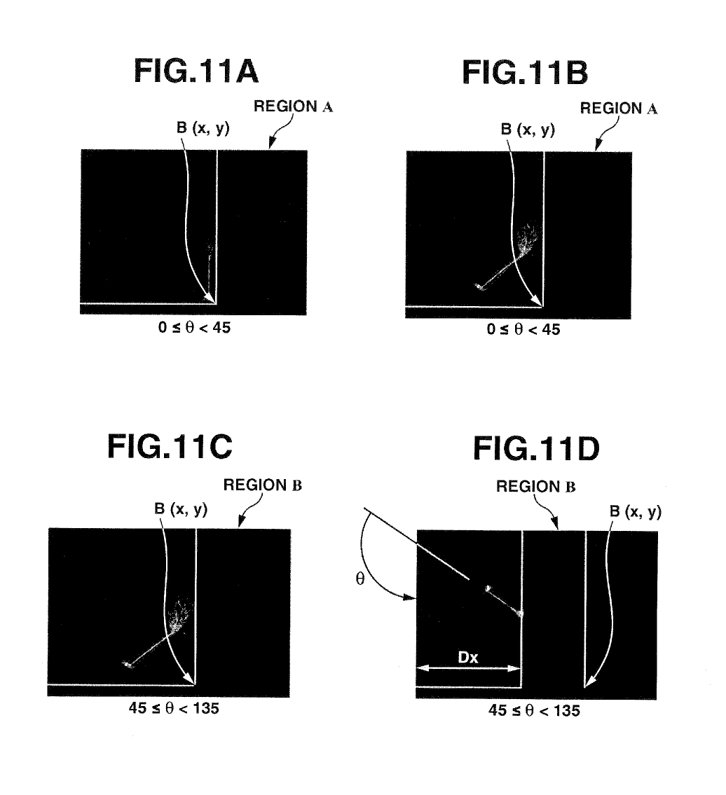

Specifically, when the club angle is between 0 degrees and 45 degrees as shown in FIGS. 11A and 11B, the non-voting region removing section 561 rewrites the pixel values in a region lower in position than the ball position B (x, y) to 0.

That is, when the expected club angle is between 0 degrees and 45 degrees, since a swing is not performed in a region to the right of the reference position B (x, y) serving as the ball position, the pixel values in the region to the right of the reference position (to the right of the reference position relative to the paper in the drawings) are set to 0. That is, in the drawings, regions A pointed to serve as non-voting regions and thus become removing targets.

Note that FIGS. 11A to 11D are schematic diagrams showing determination of a non-voting region, and FIG. 11A is a schematic diagram showing an example of determination of a non-voting region in the case of the club angle being 0 degrees, and FIG. 11B is a schematic diagram showing an example of determination of a non-voting region in the case of the angle of club being about 45 degrees.

At step S33, the non-voting region removing section 561 rewrites the pixel values in regions B in FIGS. 11C and 11D to 0.

For example, when the club angle is 45 degrees as shown in FIG. 11C, the non-voting region removing section 561 rewrites the pixel values in a region lower in position than the ball position B (x, y) to 0.

At this time, when the expected club angle is between 45 degrees and 135 degrees, since a swing is not performed in a more forward direction than the reference position (x, y) serving as the ball position, the pixel values in a region to the left of the reference position (to the right of the reference position relative to the paper in the drawings) are rewritten to 0. That is, in the drawings, regions B pointed to serve as non-voting regions and thus become removing targets.

Note that FIG. 11C is a schematic diagram showing an example of determination of a non-voting region in the case of the club angle being 45 degrees, and FIG. 11D is a schematic diagram showing an example of determination of a non-voting region in the case of the club angle being about 135 degrees.

For example, when the club angle is about 135 degrees as shown in FIG. 11D, the non-voting region removing section 561 rewrites the pixel values in a region lower in position than the ball position B (x, y) to 0.

When the club angle is about 135 degrees, since the club position is away from the reference position (B (x, y)), a club's away region is considered as a non-voting region and thus serves as a removing target. The club's away region is calculated by the following equation (4):

$${D}_{x} = Bx - \frac{θ}{2} \qquad ( 4 )$$

Note that D_{X} indicates the x coordinate value of the club end position, Bx indicates the x coordinate value of the reference position (ball position), and θ indicates the expected club angle.

At step S34, the non-voting region removing section 561 rewrites the pixel values in a region lower than a subject's lower body position to 0. Here, for the way to determine a region lower in position than a reference subject's lower body position, the determination may be made using, as a reference position, a club position obtained when a calculated angle of rotation of the club is substantially 90 degrees.

When the club angle is between 135 degrees and 210 degrees, the non-voting region removing section 561 identifies a subject's lower body and rewrites the pixel values in a region lower in position than the lower body to 0.

At step S35, the non-voting region removing section 561 rewrites the pixel values in a region lower than a subject's lower body position to 0.

When the club angle is between 210 degrees and 270 degrees, the non-voting region removing section 561 identifies a subject's lower body and rewrites the pixel values in a region lower in position than the lower body to 0.

Furthermore, since a swing is not performed in a region to the left of the reference position (a left region in the drawings), the pixel values in a region to the left of the ball position are rewritten to 0.

At step S36, the non-voting region removing section 561 rewrites the pixel values in a region to the left of the ball to 0. When the club angle is between 270 degrees and 320 degrees, the non-voting region removing section 561 considers the pixel values in a region to the left of the reference position which is the ball position (to the left of the reference position relative to the paper in the drawings), as removing targets. At this time, the pixel values in a region to the left of the ball position (to the right in the drawings) are rewritten to 0.

A non-voting region is determined according to a club position expected in the above-described manner, and the pixel values in the non-voting region are rewritten to 0.

Note that when the degree of change in club angle decreases as the imaging order proceeds, it is highly likely that the club movement is rotation movement reverse to the movement from the address to the top (the club movement changes to one from the top to the impact), and thus, club positions are expected in a reverse manner to those described above. That is, the club movement is expected to change to one from the top to the impact.

Namely, in the present embodiment, since the club angle in swing motions changes from 0 degrees to 45 degrees, from 45 degrees to 135 degrees, from 135 degrees to 210 degrees, from 210 degrees to 270 degrees, and then from 270 degrees to 320 degrees as the imaging order proceeds, the swing motions are expected to be motions from the address to the top. Thereafter, as the swing motions approach the top, generally, the degree of change in club angle decreases. Then, the club angle changes, in a reverse manner to the above-described motions, from 320 degrees to 270 degrees, from 270 degrees to 210 degrees, from 210 degrees to 135 degrees, from 135 degrees to 45 degrees, and then from 45 degrees to 0 degrees. Thus, the swing motions are expected to be motions between the top and the impact. Swing motions after the impact are also expected in the same manner.

Therefore, the image capturing apparatus 1 can determine, from captured images which are obtained by imaging a series of swing motions, club angles in the respective captured images and generate a graph that identifies swing positions.

The image capturing apparatus 1 configured in the above-described manner includes the image obtaining section 51, the difference image generating section 54, the enhanced image generating section 55, the Hough transform section 562, and the angle determining section 151.

The image obtaining section 51 obtains a plurality of image data where subject motion is captured continuously.

The difference image generating section 54 generates difference image data between a plurality of image data temporally adjacent to each other, from the plurality of image data obtained by the image obtaining section 51.

The enhanced image generating section 55 generates image data for identifying the subject motion, from the difference image data generated by the difference image generating section 54.

The Hough transform section 562 performs a computation process (Hough transform process) on the image data generated by the enhanced image generating section 55.

The angle determining section 151 identifies a change point of the subject motion, based on a computation result obtained by the Hough transform section 562.

Therefore, the image capturing apparatus 1 of the present invention can identify club angles from a series of obtained captured images. In addition, subject's swing positions can be identified based on the identified club angles. Furthermore, the subject's swing positions can be used for swing evaluation, etc.

The image capturing apparatus 1 further includes the graphing section 152 that generates graph data representing club angles identified by the angle determining section 151, based on voting results of a Hough transform performed by the Hough transform section 562.

Therefore, the image capturing apparatus 1 can generate a graph that visualizes changes in club angle in continuously captured images. A user can easily recognize changes in club angle by the graph.

The image capturing apparatus 1 further includes the reference position determining section 52 and the non-voting region removing section 561.

The reference position determining section 52 detects specification of a reference position for the plurality of image data obtained by the image obtaining section 51.

The non-voting region removing section 561 replaces data in a region in the image data generated by the Hough transform section 562, with another data based on the reference position detected by the reference position determining section 52, and thereby removes the region from a target of a computation process.

The Hough transform section 562 performs a computation process (Hough transform process) on an image where the region is removed by the non-voting region removing section 561.

Therefore, the image capturing apparatus 1 can improve golf club extraction accuracy without an unnecessary straight line being extracted in a Hough transform.

The image capturing apparatus 1 further includes the comparison graph extracting section 43 and the display control section 44.

The comparison graph extracting section 43 sets another graph data for comparing with the graph data generated by the graphing section 152.

The display control section 44 controls to display and output another graph data set by the comparison graph extracting section 43, so as to be superimposed on the graph data generated by the graphing section 152.

Therefore, the image capturing apparatus 1 can, for example, display such that a graph representing changes in professional's club angle which serves as a comparison graph is superimposed on a graph representing changes in club angle in user's swing motions. By this, the user can easily understand comparison with another person. The comparison graph is not limited to a graph representing changes in professional's club angle, and user's swing motions analyzed in the past may be superimposed on the graph for comparison.

The image capturing apparatus 1 further includes the luminance image converting section that converts the plurality of image data into luminance image data.

The difference image generating section 54 generates difference image data from the luminance image data.

In the present embodiment, the subject motion is a series of golf swing motions. Note that the subject motion is not limited to golf swing motions and can be any as long as a rod moves with the change in position; for example, the subject motion may be motion for baseball, kendo, kyudo (archery), etc.

It is to be noted that the present invention is not limited to the above-described embodiment and modifications, improvements, and the like, that fall within the range in which the object of the present invention can be achieved are included in the present invention.

Note that if, as a result of a comparison between adjacent frames, the frames have abnormal angles, then the frames are not used as graph targets. Therefore, as shown in the drawings, an image portion with an abnormal value shows blank.

Although in the above-described embodiment the enhanced image generating section 55 generates an enhanced image by multiplying together the pixel values of a difference image and the pixel values of a difference image immediately before the difference image, the present invention is not limited thereto. As long as an enhanced image can be generated, the enhanced image generating section 55 can use any method and may, for example, add or subtract pixel values. Although, upon generating an enhanced image, a difference image immediately before an enhancement target image is used, the present invention is not limited thereto. A difference image immediately after the enhancement target image may be used or an enhanced image may be generated by using a plurality of (three or more) images.

Although in the above-described embodiment the weighting section 563 is configured to highly evaluate, in voting results, a region near an estimated club position, the present invention is not limited thereto. Namely, the configuration can be any as long as a region near an estimated club position is relatively highly evaluated in voting results. Thus, for example, the configuration may be such that those regions other than the region near the estimated club position are evaluated lower.

Although the above-described embodiment describes an example in which a right-handed person performing a swing is captured as a subject and a graph representing changes in club position is generated from the captured images, it is also possible that a left-handed person performing a swing is captured as a subject and a graph representing changes in club position is generated from the captured images. This case is made possible by, for example, performing processes using a reverse algorithm to that in the above-described embodiment or performing processes such that captured images are reversed using a known mirror-image process.

Although in the above-described embodiment the image capturing apparatus 1 to which the present invention is applied is described using, as an example, a digital camera, the present invention is not particularly limited thereto.

For example, the present invention can be applied to electronic equipment in general having a graph display processing function. Specifically, for example, the present invention can be applied to notebook personal computers, printers, television receivers, video cameras, portable navigation apparatuses, mobile phones, portable game machines, etc.

The above-described series of processes can be performed by hardware or can be performed by software.

In other words, the functional configurations shown in FIGS. 2 and 3 are merely illustrative and thus are not particularly limited. Namely, it is sufficient that the image capturing apparatus 1 have a function capable of performing the above-described series of processes as a whole, and what functional blocks are used to implement the function are not particularly limited to the examples in FIGS. 2 and 3.

A single functional block may be configured by hardware alone or may be configured by software alone or may be configured by a combination thereof.

When a series of processes are performed by software, a program constituting the software is installed on a computer, etc., via a network or from a recording medium.

The computer may be a computer incorporated in dedicated hardware. Alternatively, the computer may be a computer capable of performing various functions by installing various programs, e.g., a general-purpose personal computer.

A recording medium including such a program is not only configured by the removable medium 31 in FIG. 1 which is distributed separately from the apparatus main body in order to provide a user with the program, but is also configured by, for example, a recording medium which is provided to the user, incorporated in advance in the apparatus main body. The removable medium 31 is configured by, for example, a magnetic disk (including a floppy disk), an optical disk, a magneto-optical disk, or the like. The optical disk may be configured by, for example, a CD-ROM (Compact Disk-Read Only Memory), a DVD (Digital Versatile Disk), or the like. The magneto-optical disk is configured by an MD (Mini-Disk) or the like. The recording medium which is provided to the user, incorporated in advance in the apparatus main body is configured by, for example, the ROM 12 in FIG. 1 having a program recorded therein, a hard disk included in the storage section 21 in FIG. 1, or the like.

Note that in the specification the steps describing a program recorded in a recording medium not only include processes that are performed in the order of the steps in a time-series manner, but also include processes that are not necessarily processed in a time-series manner but are performed in parallel or individually.

In the specification, the terms for a system each refer to an overall apparatus configured by a plurality of apparatuses, a plurality of means, etc.

Although the embodiment of the present invention has been described above, the embodiment is merely illustrative and do not limit the technical scope of the present invention. The present invention can employ various other embodiments, and furthermore, various changes such as omission and replacement may be made therein without departing from the true spirit of the present invention. These embodiments and modifications thereto are included in the true scope and spirit of the present invention described in the specification, etc., and are included in the inventions described in the appended claims and in the range of equivalency of the inventions.

What is claimed is:

1. An image processing apparatus comprising:
an obtaining section which obtains a plurality of image data in which a subject motion is captured continuously;
a first generating section which generates difference image data between temporally adjacent ones of the plurality of image data;
a second generating section which generates identifying image data for identifying the subject motion, based on the difference image data generated by the first generating section; and
a change point identifying section which identifies a change point of the subject motion, based on the identifying image data generated by the second generating section.

2. The image processing apparatus according to claim 1, further comprising a computation processing section which performs a computation process on the identifying image data generated by the second generating section, wherein
the change point identifying section identifies the change point of the subject motion, based on a computation result produced by the computation processing section.

3. The image processing apparatus according to claim 2, further comprising a third generating section which generates graph data representing change points identified by the change point identifying section, based on the computation result obtained by the computation processing section.

4. The image processing apparatus according to claim 2, further comprising:
a position determining section which determines a reference position for the plurality of image data obtained by the obtaining section; and
a removing section which replaces data in a region in the identifying image data generated by the second generating section, with another data based on the reference position determined by the position determining section, to thereby remove the region from a target of the computation process performed by the computation processing section,
wherein
the computation processing section performs the computation process on image data output by the removing section.

5. The image processing apparatus according to claim 3, further comprising:
a setting section which sets another graph data for comparison with the graph data generated by the third generating section; and
a display control section which controls to display and output the another graph data set by the setting section, so as to be superimposed on the graph data generated by the third generating section.

6. The image processing apparatus according to claim 1, further comprising a converting section which converts the plurality of image data into luminance image data, wherein
the first generating section generates the difference image data from the luminance image data.

7. The image processing apparatus according to claim 2, wherein
the computation processing section includes a straight line identifying section which performs a Hough transform process on the identifying image data generated by the second generating section, and thereby identifies an approximate straight line in the identifying image data, and
the change point identifying section identifies change points based on angles of approximate straight lines identified by the straight line identifying section and timings at which the image data are obtained by the obtaining section.

8. The image processing apparatus according to claim 1, wherein
the subject motion comprises a golf swing motion.

9. An image processing method comprising:
an obtaining step of obtaining a plurality of image data in which a subject motion is captured continuously;
a first generating step of generating difference image data between temporally adjacent ones of the plurality of image data;
a second generating step of generating identifying image data for identifying the subject motion, based on the difference image data generated by a process in the first generating step; and
a change point identifying step of identifying a change point of the subject motion, based on the identifying image data generated by a process in the second generating step.

10. A recording medium readable by a computer and recording a program that causes the computer to function as:
an obtaining section which obtains a plurality of image data in which a subject motion is captured continuously;
a first generating section which generates difference image data between temporally adjacent ones of the plurality of image data;
a second generating section which generates identifying image data for identifying the subject motion, based on the difference image data generated by the first generating section; and
a change point identifying section which identifies a change point of the subject motion, based on the identifying image data generated by the second generating section.
